(19) United States
(12) Patent Application Publication
(10) Pub. No.: US 2013/0094750 A1
(43) Pub. Date: Apr. 18, 2013

(54) METHODS AND SYSTEMS FOR SEGMENTATION OF CELLS FOR AN AUTOMATED DIFFERENTIAL COUNTING SYSTEM

(71) Applicants: Tolga Tasdizen, Salt Lake City, UT (US); Nisha Ramesh, Salt Lake City, UT (US); Mohamed Salama, Salt Lake City, UT (US)

(72) Inventors: Tolga Tasdizen, Salt Lake City, UT (US); Nisha Ramesh, Salt Lake City, UT (US); Mohamed Salama, Salt Lake City, UT (US)

(21) Appl. No.: 13/650,387

(22) Filed: Oct. 12, 2012

Related U.S. Application Data
(60) Provisional application No. 61/546,518, filed on Oct. 12, 2011.

(51) Int. Cl. G06K 9/34

(52) U.S. Cl. 382/134

(57) ABSTRACT

A method of identifying individual cells in an image of a cytological preparation. The method includes the steps of obtaining an image of a cytological preparation including a plurality of cells; identifying a first region of the image, the first region having a region boundary encompassing at least one lobe, wherein the first region includes at least one cell; detecting at least one circle within the first region, where the at least one circle substantially covers the at least one lobe of the first region; and if the first region has more than one circle, splitting the region into at least two subregions.

### CROSS-REFERENCE TO RELATED APPLICATIONS

This application claims the benefit of U.S. provisional application No. 61/546,518 filed Oct. 12, 2011, which is incorporated herein by reference in its entirety.

### BACKGROUND

The present invention relates to methods and systems for automatically identifying individual cells in an image.

The principal types of cells present in the peripheral blood are red blood cells (RBCs), white blood cells (WBCs) and platelets. FIG. 1.1 shows an example of peripheral blood smear sample. The percentage of WBC subtypes normally observed in human blood typically ranges between the following values: neutrophils 50-70%, eosinophils 1-5%, basophils 0-1%, monocytes 2-10%, lymphocytes 20-45%. These cells provide a defense mechanism against infections in an organism. Their specific proportions can help specialists to determine the presence of various pathology conditions (i.e. the presence of mononucleosis, hepatitis diabetes, allergy, arthritis, anemia, malignancies and many others).

The observation of blood smear under a microscope provides important qualitative and quantitative information concerning the diagnosis of various diseases including leukemia. FIG. 1.2 shows examples of the different subtypes of WBCs. WBC identification and classification into these subtypes is very important in laboratory testing. This operation is performed by experienced technicians, who perform two main analyses. The first is the qualitative study of the morphology of the WBCs which gives information about the adequacy of the smear among other parameters including degenerative nature of cells. The second is quantitative and it consists of differential counting of the WBCs. FIG. 1.3 shows the distribution of the WBC subtypes. The accuracy of cell classification and counting is strongly affected by individual operators' capabilities. In particular, the identification and the differential count of bloods cells is a time-consuming and repetitive task that can be influenced by the operators' accuracy and tiredness. Substituting automatic detection of WBC for manually locating, identifying and counting different classes of cells is an important topic in the domain of clinical diagnostic laboratories. Therefore, automation of this task can be very helpful for accelerating diagnosis of many diseases. Our proposed method has been applied successfully to a large dataset. It achieves good classification accuracy for all of the WBC subtypes.

Unlike peripheral blood smear evaluation, the evaluation of bone marrow is limited to those clinical situations in which hematologic or other abnormalities already have been identified and require further characterization or investigation. In other words, a bone marrow evaluation is usually not a baseline test, but rather a confirmatory test used to rule in or rule out specific hypotheses. Hematopoietic cells in the bone marrow give rise to all the blood cell types. They are grouped into Erythrocyte or Normoblast differentiation series, Leukocyte differentiation series and megakaryocytes. FIG. 2 shows a bone marrow sample. These cells are involved in the production of Red blood cells (RBCs), White blood cells (WBCs) and platelets. A bone marrow evaluation helps to evaluate blood cell production, diagnose leukemia, diagnose a bone marrow disorder, diagnose and stage a variety of other types of cancer that may have spread into the marrow. A bone marrow evaluation is used to confirm diseases like Aplastic Anemia, Acute leukemia, Myelodysplastic Syndrome, Chronic Myelogenous leukemia, Myelofibrosis and Essential Thrombocythemia, Multiple Myeloma, Severe thrombocytopenia. It may be needed when staging certain cancers. Staging is a careful and thorough examination and classification of how far the cancer has spread and what body organs are involved. Thus, evaluation of the bone marrow is extremely important.

### SUMMARY

In one embodiment, the invention provides a method of identifying individual cells in an image of a cytological preparation. The method includes the steps of obtaining an image of a cytological preparation including a plurality of cells; identifying a first region of the image, the first region having a region boundary encompassing at least one lobe, wherein the first region includes at least one cell; detecting at least one circle within the first region, where the at least one circle substantially covers the at least one lobe of the first region; and if the first region has more than one circle, splitting the region into at least two subregions.

In another embodiment, the invention provides a computer-readable medium which includes first instructions executable on a computational device for obtaining an image of a cytological preparation including a plurality of cells; second instructions executable on a computational device for identifying a first region of the image, the first region having a region boundary encompassing at least one lobe, wherein the first region includes at least one cell; third instructions executable on a computational device for detecting at least one circle within the first region, where the at least one circle substantially covers the at least one lobe of the first region; and fourth instructions executable on a computational device for splitting the region into at least two subregions if the first region has more than one circle.

In yet another embodiment, the invention provides a computer-based system for identifying individual cells in an image of a cytological preparation. The system includes a microprocessor and a storage medium operably coupled to the microprocessor. The storage medium includes program instructions executable by the microprocessor for obtaining an image of a cytological preparation including a plurality of cells; identifying a first region of the image, the first region having a region boundary encompassing at least one lobe, wherein the first region includes at least one cell; detecting at least one circle within the first region, where the at least one circle substantially covers the at least one lobe of the first region; and if the first region has more than one circle, splitting the region into at least two subregions.

Other aspects of the invention will become apparent by consideration of the detailed description and accompanying drawings.

### BRIEF DESCRIPTION OF THE DRAWINGS

FIG. 1.1 shows a sample peripheral blood smear;

FIG. 1.2 shows examples of WBC subtypes;

FIG. 1.3 shows distribution of WBC subtypes;

FIG. 2 shows a bone marrow sample;

FIG. 3.1 shows a flowchart for WBC detection;

FIG. 3.2 shows detection of WBCs;

FIG. 3.3 shows a cropped WBC;

FIG. 3.4 shows a flowchart for WBC segmentation;

FIG. 3.5 shows segmentation of a WBC;

FIG. 3.6 shows a segmented WBC;

FIG. 3.7 shows steps of classification of WBCs;

FIG. 3.8 shows examples of WBC with segmented and non-segmented nuclei;

FIG. 3.9 shows steps representing segmented vs. non-segmented nucleus classification;

FIG. 4.1 shows segmentation results;

FIG. 4.2 shows examples showing band and neutrophil;

FIG. 5.1 shows a bone marrow sample;

FIG. 5.2 shows a morphologically processed bone marrow image;

FIG. 5.3 shows circle detection on the morphologically processed image;

FIG. 5.4 shows a flowchart for hematopoietic cell segmentation;

FIG. 5.5 shows steps representing the splitting algorithm;

FIG. 5.6 shows cell boundaries superimposed on the original image;

FIG. 6.1 shows a first Example of segmentation of hematopoietic cells;

FIG. 6.2 shows a second Example of segmentation of hematopoietic cells;

FIG. 6.3 shows a third Example of segmentation of hematopoietic cells;

FIG. 6.4 shows magnified views of segmentation of hematopoietic cells;

FIG. 6.5 shows magnified views of segmentation of hematopoietic cells; and

FIG. 7 shows a computer system for implementation of embodiments of the invention.

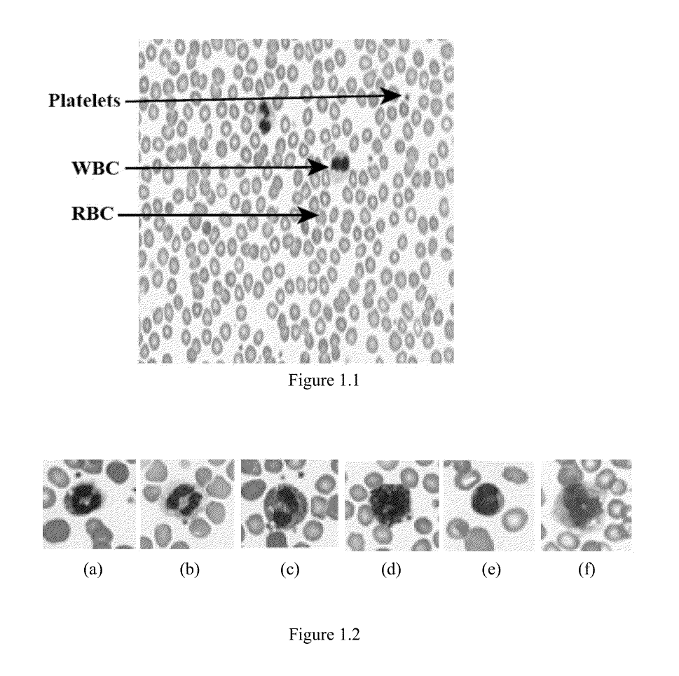

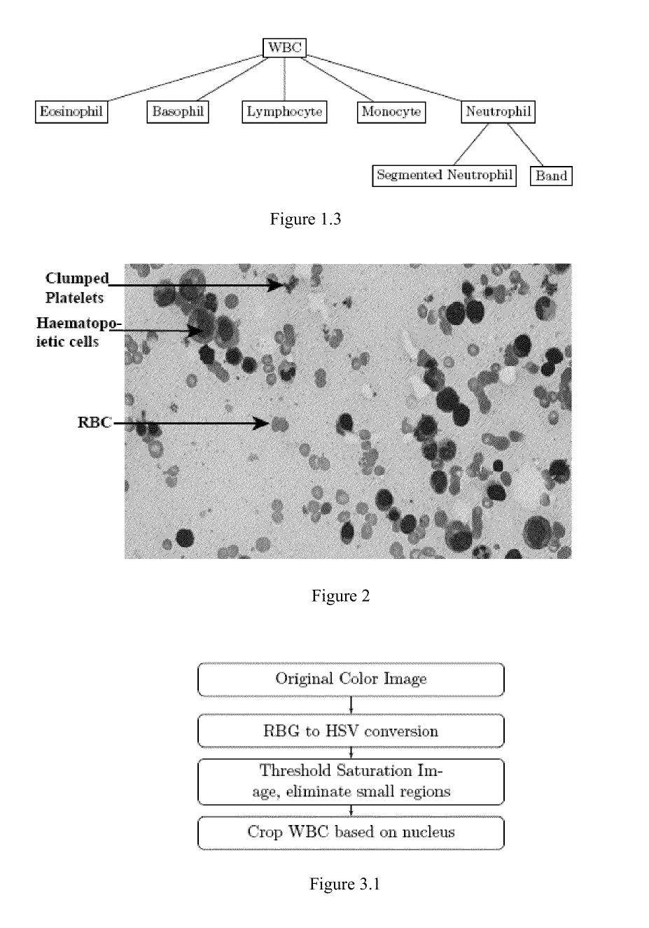

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In various embodiments, the system includes a computer with a microprocessor, memory, data storage, and input and output capabilities. The computer obtains digital images of cytological slides (e.g. from a digital camera or slide scanning system), where the samples on the slides may be stained so that the nuclei are dark (e.g. blue) and the cytoplasm is a contrasting color (e.g. pink), for example using Wright's stain or a related stain combination; other combinations of transmitted light or fluorescent dyes and labels are also possible, including, for example, Hoechst nuclear dye and F-actin phalloidin stain. The computer may be programmed to perform any of the methods described herein, e.g. using the microprocessor, and display results of performing the methods at various stages. For example, the computer may store and/or display to a user (e.g. a clinician) data similar to the images disclosed herein. In addition, the computer may accumulate numerical results, e.g. numbers of cells in an image or a portion thereof, to store and/or display. Thus, in various embodiments, the invention includes a computer-readable medium containing instructions for the microprocessor to perform the methods disclosed herein. The methods and systems described herein can be used to identify individual cells and to automatically identify single cells present in adjacent groups or clumps and to further segment the cells into nuclear and cytoplasmic regions. Image intensity data in the segmented regions can be quantified, e.g. using the grayscale values or using an adjusted value based on a calibration. The methods and systems can be used with a number of cell types, such as those exemplified herein as well as other types including primary cells and cultured cells, including cells of a hepatoma cell line.

In one embodiment, the invention includes a method of segmenting cells in an image of a cytological preparation. The method includes a step of obtaining an image of a cytological preparation including a plurality of cells. The method also includes a step of identifying a first region of the image, the first region having a region boundary encompassing at least one lobe, wherein the first region includes at least one cell. The method further includes a step of detecting at least one circle within the first region, where the at least one circle substantially covers the at least one lobe of the first region. If the first region has more than one circle, the method includes a step of splitting the region into at least two subregions. In various embodiments, the step of identifying at least one circle within the first region includes identifying at least one circle within the first region using a circular Hough transform. In certain embodiments, each of the at least two subregions includes a cell.

The step of splitting the region into at least two subregions includes, in certain embodiments, steps of i) identifying a plurality of maximum curvature points on the region boundary, ii) generating a plurality of vectors connecting pairs of the plurality of maximum curvature points, and iii) eliminating invalid vectors to produce a set of remaining vectors. For each of the remaining vectors, the method includes steps of a) determining a tangent for each of the maximum curvature points, where each tangent has an angle, b) comparing the angles of the tangents, and c) eliminating the remaining vector if the difference between the angles of the tangents is not approximately equal to pi radians to produce a set of final vectors. Finally, splitting the region into at least two subregions includes a step of v) splitting the region into at least two subregions using at least one of the final vectors.

The step of eliminating invalid vectors includes, in some embodiments, eliminating any of the plurality of vectors which cross the region boundary or which are not within the first region. The step of generating a plurality of vectors connecting pairs of the plurality of maximum curvature points includes generating a plurality of vectors connecting pairs of the plurality of maximum curvature points using Delaunay triangulation.

In various embodiments, the method further includes a step of validating the final vectors.

In further embodiments, the step of identifying a first region includes steps of thresholding the image, subtracting a first color channel of the image from a second color channel of the image to selectively remove a first set of image features, applying a hole filling algorithm, and applying a disk-shaped structuring element.

In still further embodiments, the each of the at least two subregions includes a cell. In other embodiments, the first region includes a plurality of lobes, wherein each of the plurality of lobes has a cell therein, and wherein splitting the region into at least two subregions includes splitting the region such that each subregion includes one of the plurality of lobes.

In other embodiments, the method includes a step of segmenting at least a portion of the first region into a nuclear region and a cytoplasmic region. The step of segmenting at least a portion of the first region into a nuclear region and a cytoplasmic region can include one or more of thresholding the first region based on intensity, thresholding the first region based on RGB color channel differences, applying a disk-shaped structuring element, identifying a boundary of a nucleus to obtain the nuclear region, and subtracting the nuclear region from the first region to obtain the cytoplasmic region. The method, in yet other embodiments, includes a step of quantifying a staining intensity in at least one of the nuclear region and the cytoplasmic region.

In various embodiments, at least one step of the method is executed using a microprocessor. In other embodiments, the method includes a step of displaying a result to a user on an output device, wherein the result is one of an image or a numerical value.

In some embodiments, the invention includes a computer-readable medium containing program instructions for implementing a method of identifying individual cells in an image of a cytological preparation, wherein execution of the program instructions by a microprocessor of a computer system causes the microprocessor to carry out the steps of the method of any of the preceding claims. In other embodiments, the invention includes a computer system for identifying individual cells in an image of a cytological preparation, the computer system including a microprocessor, memory, data storage, and input and output capabilities, wherein the computer system executes the program instructions contained on the computer-readable medium.

Disclosed herein is a methodology to achieve an automated system for the segmentation of hematopoietic cells from scanned slide microscopic images. This segmentation technique is effective in segmenting both individual and clumped hematopoietic cells. The similar intensity regions that correspond to noise have been eliminated.

Also disclosed is a methodology to achieve an automated system for the detection and classification of normal WBCs from scanned slide microscopic images. The subtypes of WBCs identified are basophil, eosinophil, lymphocyte, monocyte, band and segmented neutrophil. Experiments show that the two step classification implemented achieves a 93.9% and 88.4% overall accuracy in the 5 subtype and 6 subtype classification respectively. Results indicate that the morphological analysis of bloods white cells is achievable and it offers good classification accuracy.

Disclosed is an automated system for differential white blood cell (WBC) counting can make the classification of blood cells much faster and less tedious for the technician. We present an automated system for the segmentation and classification of the WBC in the peripheral blood smear from scanned slide images. A new segmentation scheme using color information and morphology is proposed. Then, as the first step of a two-step classification process, a WBC is broadly classified into cells with segmented nucleus and cells with non-segmented nucleus. The nucleus shape is the key factor in deciding which general class the WBC belongs to. Ambiguities associated with connected nuclei lobes are resolved by detecting maximum curvature points and partitioning them using geometric rules. The second step is to obtain a desired set of features using the information from the cytoplasm and nucleus regions to classify the WBC to its final type. We use these features with Linear Discriminant Analysis. This novel two-step classification approach stratifies normal WBC types accurately. System evaluation is performed using 10-fold cross-validation technique. Confusion matrices of the classifiers is presented to evaluate the accuracy for each type of WBC detection.

Bone marrow evaluation are indicated when peripheral blood abnormalities are not explained by the clinical, physical, or laboratory findings. In the bone marrow, the process of locating, identifying and counting of hematopoietic cells manually is tedious and time consuming for the technician. We propose an extension to the previous segmentation method discussed for the peripheral blood smear. We use color information and morphology to eliminate red blood cells and background. The clumped cells are segmented using circle detection on the morphologically processed image and a splitting algorithm based on the detected circle centers. Circular Hough Transform is used for circle detection to find the position and number of circle centers in each region. The splitting algorithm is based on detecting the maximum curvature points, and partitioning them based on information obtained from the centers of the circles in each region. The performance of the segmentation algorithm for hematopoietic cells is evaluated on a set of 3,748 cells.

The presently-disclosed methods for segmentation of hematopoietic cells are different from known approaches in several respects. For example, clumped cells are differentiated from single cells so that circle detection and cell-splitting algorithms are only applied to the clumped cells. In addition, RBC are eliminated before detecting the hematopoietic cells.

We describe herein the development of an automated system for the segmentation and classification of the WBC in the peripheral blood smear from scanned slide images. In addition, we describe the development of an algorithm for segmentation of hematopoietic cells in bone marrow from scanned slide images.

This study leads to development of image analysis in the field of pathology and development of an automated tool to identify and classify the WBC from peripheral blood smear and hematopoietic cells in the bone marrow. The results of this study are intended to lead to the replacement of the manual counting of WBCs and hematopoietic cells, which is a tiresome and time-consuming process, by an automated system that is objective and consistent. The proposed automated morphological classification system is a first step towards the automatic detection/monitoring of blood pathologies such as various leukemia types by inspecting the variation in morphology of WBCs.

WBC Segmentation in Peripheral Blood Smear

Segmentation is a critical step in many image analysis problems. The segmentation step is crucial because the accuracy of the subsequent feature extraction and classification step depends on correct segmentation of WBCs. It is also a difficult and challenging problem due to the complex appearance of these cells, uncertainty and inconsistencies in the microscopic image with varying illumination. Improvement of cell segmentation has been the most common effort in many research efforts. Many automatic segmentation methods have been proposed, most of them based on local image information such as histogram of regions, pixel intensity, discontinuity and clustering techniques.

Many of the segmentation algorithms are based on the edge information present in images. We discuss several of these approaches next. As proposed by Ongun, WBCs were segmented using active contour models (snakes and balloons) which were initialized using morphological operators. This method works well only if the WBC are distinctly separate from the red blood cells and have a dark cytoplasm.

Kumar defined a new edge operator, the Teager energy operator, to highlight the nucleus boundary which is very effective for segmenting the nuclei in cell images. Kumar used a simple morphological method to segment the cytoplasm from the background and the RBCs. The cytoplasm segmentation works well when the RBC and WBC are not close to each other. In contrast, our method works well even with a complicated background. Jiang introduced a novel WBC segmentation scheme by combining scale-space filtering and watershed clustering. Scale space filtering is used to obtain the nucleus from the sub-image. Watershed clustering in 3-D HSV (Hue, Saturation, Value) histogram is processed to extract the cytoplasm. However, this method may not be sufficient in the case of high density of cells, where the RBC are clustered close to the WBC.

To overcome the difficulty associated with the high density of cells, Dorini introduces the use of some simple morphological operators and explores the scale-space properties of a toggle operator to improve the segmentation accuracy in the WBCs. To avoid leaking, a common problem in cell images due to the low contrast between nucleus, cytoplasm and background, they used a scale-space toggle operator for contour regularization. This shows the importance of the multiscale. In this method, the cytoplasm segmentation presents a few limitations. The RBC touching the WBC also get detected as part of the cytoplasm. In our method we eliminate the RBCs before detecting the WBC.

The above-mentioned algorithms are based on edge information. Edge detection methods do not work very well when not all cell details are sharp. But these methods work well if the contrast between the background and the gray internal membrane of the cell is stretched using a contrast stretching filter as stated by Piuri and Scotti. However, the problem of overlapping red and white blood cells still remains unresolved. Sadeghians method used Zacks simple thresholding method for cytoplasm segmentation, which is based on the fact that the color intensity of RBC in a blood image is quite different from that of cytoplasm. The nuclei segmentation was done using a GVF (Gradient Vector Flow) snake.

A few approaches that were introduced recently dealt only with the segmentation of the nucleus of the WBC. For instance, Hamghalam and Ayatollahi used histogram analysis and measurement of distance among nuclei. The thresholding point was chosen based on the histogram analysis. Nuclei whose distances are less than the diameter of the WBC were merged.

Rezatofighi introduced a novel method based on orthogonality theory and Gram-Schmidt process for segmenting the WBC nuclei. In these two approaches, cytoplasm segmentation was not addressed. We address cytoplasm segmentation in addition to nuclei segmentation. The successful segmentation of the cytoplasm along with the nucleus segmentation aids in the automatic classification of the WBC. As a part of our preliminary studies we implemented the segmentation of WBCs based on the algorithm proposed by Dorini.

WBC Classification in Peripheral Blood Smear

WBCs are classified according to the characteristics of their cytoplasm and nucleus. The WBCs are classified into five classes, i.e., monocyte, lymphocyte, neutrophil, eosinophil and basophil. Pathologists mostly consider this five subtype classification. The neutrophils can be further subdivided into segmented neutrophils and bands. Since the chosen features affects the classifier performance, deciding which features must be used in a specific data classification problem is as important as the classifier itself. Hematology experts examine the shape of the cells and the nuclei, color and texture of the cells. It is important to reflect the rules and heuristics used by the hematology experts in selection of the features. Several researchers have previously proposed features to differentiate the WBCs.

As proposed by Ongun, several types of features such as intensity and color based features, texture based features and shape based features are utilized for a robust representation of the WBC. Classification method used in this work includes k-Nearest Neighbors (k-NN), Learning Vector Quantization (LVQ), MultiLayer Perceptron (MLP) and Support Vector Machine (SVM).

Piuri and Scotti evaluated the binarized cytoplasm membrane and the nucleus to characterize the feature set. The standard set of features like area, perimeter, convex areas, solidity, major axis length, orientation, filled area, eccentricity were separately evaluated for the nucleus and the cytoplasm. In addition special features like the ratio between the nucleus and the cell areas, the nucleus' “rectangularity” (ratio between the perimeter of the tightest bounding rectangle and the nucleus perimeter), the cell “circularity” (ratio between the perimeter of the tightest bounding circle and the cell perimeter), number of lobes in nucleus, area and mean gray-level intensity of the cytoplasm were computed. Their system was evaluated using 10 fold cross-validation. The performance was compared using different classifiers like nearest neighbor classifiers (kNN), Feed-forward neural network (FF-NN), Radial Basis Function neural network (RBF), parallel classifier built with feed-forward neural network. In our method we suggest a preliminary classification of the WBC based on the number of lobes (single or multi-lobed) in the nucleus along with the feature set to get a better classification rate for each of the WBC subtype. As a part of the preliminary studies the features we evaluated were based on features selected by Scotti and Piuri.

Our approach aims at achieving a robust scheme to identity the WBC accurately. False negatives in identification of WBC can lead to wrong diagnosis. We propose a segmentation scheme based on the difference in color channels and morphological operations to segment the WBC. The algorithm has low computation cost but good accuracy. Two-step classification with the aid of a comprehensive feature set is helpful in realizing better accuracy rates in the classification of the WBCs. We validate our approach on 320 images with 1,938 cells.

Segmentation of Hematopoietic Cells in Bone Marrow

Image segmentation in the bone marrow is a difficult and challenging problem due to the complex appearance of these cells, uncertainty and inconsistencies in the microscopic image with varying illumination. There is fairly a wide variation of size and shape of nuclei and cytoplasm regions within given cell classes, making the segmentation problem a bigger challenge. The maturity classes of the cells in the bone marrow actually represent a continuum. Furthermore, cells frequently overlap each other. Improvement of cell segmentation has been the most common effort in many research efforts. As proposed by Ongun, hematopoietic cells can be segmented in a manner similar to the segmentation of the blood cells in the peripheral blood smear. A few approaches deal only with the segmentation of the Leukocyte differentiation series in the bone marrow samples, which reveals important diagnosis information about patients. Most of the segmentation methods for the Leukocyte differentiation series in bone marrow are based on Fuzzy Logic. Park and Keller introduced a technique based on the Principle of Least Commitment for the segmentation of the Leukocyte differentiation series in the bone marrow. The watershed algorithm is used to perform an “over-segmentation” of the image where each primitive patch is no bigger than one of the cell components. The patch label memberships were relaxed in order to obtain more consistent labels for merging into cell objects. Similarly, Sobrevilla uses an approach based on fuzzy techniques to segment the Leukocyte differentiation series in bone marrows. They detect the interest regions, containing cells that belong to the Leukocyte differentiation series and no interest regions, containing background, red blood cells using local features like gray level intensity, homogeneity. Hematopoietic cell segmentation in the bone marrow is in a rudimentary stage and has a lot of scope for improvement.

An algorithm based on morphological watersheds was proposed by Malpica et al. and tested on the segmentation of microscopic nuclei clusters. The method fails when multiple nuclei exist in a single cell. Our method uses circle detection to find the number of cells in a given region, segments cells with multiple nuclei correctly. The methods proposed by Berge et al., Kong et al., Wen et al. are studied for splitting clumped cells.

The present disclosure describes a robust scheme to identify the WBC accurately in peripheral blood smear. A segmentation scheme with low computation cost but good efficiency has been implemented. In addition to the evaluation of the peripheral blood smear, we have segmented the hematopoietic cells from aspirate smears in the bone marrow. Our segmentation algorithm is based on a novel application of the Hough Transform to find circles in images and a splitting algorithm based on the detected circle centers.

This portion of the disclosure includes four sections. The first section gives a brief overview about mathematical morphology operators used in this work. The second section describes the algorithm for the detection and classification of WBCs in peripheral blood smear. The third section elucidates the first step of a two-step classification process, a WBC is broadly classified into cell with segmented nucleus and cell with non-segmented nucleus. The last section describes the set of features used to classify the WBC to its final type.

Morphological Tools

Mathematical morphology has been used in many operations for the segmentation of the nucleus and the cytoplasm. The most important morphological tools used are erosion and dilation.

Dilation: With A and B as sets in Z², the dilation of A by B, is defined as

A⊕B={z|(\hat{B})_{z}∩A≠φ} (3.1)

This equation is based on reflecting B about its origin, and shifting this reflection by z. The reflection of set B, denoted by \hat{B}, is defined as

\hat{B}={w|w=−b, for bεB}.

The dilation of A by B then is a set of all displacements, z, such that \hat{B} and A overlap by at least one element. B is commonly referred to as the structuring element.

Erosion: With A and B as sets in Z², the erosion of A by B, is defined as

A⊖B={z|(B)_{z} [symbol] A} (3.2)

In words, this equation indicates that erosion of A by B is the set of all points z such that B, translated by z, is contained in A.

Opening: Morphological opening generally smoothes the contour of an object, breaks narrow isthmuses, and eliminates thin protrusions. The opening of a set A by structuring element B, denoted as A∘B is defined as

A∘B=(A⊖B)⊕B (3.3)

Closing: Closing tends to smooth sections of contours, it generally fuses narrow breaks and long thin gulfs, eliminates small holes and fills gaps in the contour. The closing of a set A by structuring element B, denoted as A•B is defined as

A•B=(A⊕B)⊖B (3.4)

Detection and Segmentation of White Blood Cells from Peripheral Blood Smear

We developed an automated system for the detection of the WBCs from blood smears. WBC counting is performed by pathologists only in thin sections of the blood smear since they have a single layer of cells. Similarly, we manually pick these regions and store the images corresponding to the thin sections of the blood smear. Each of these images has 2 to 15 WBCs.

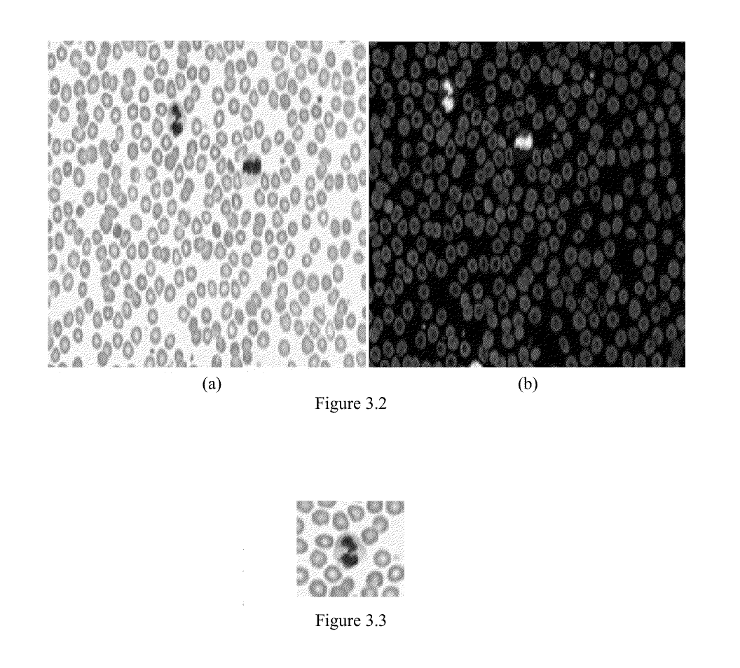

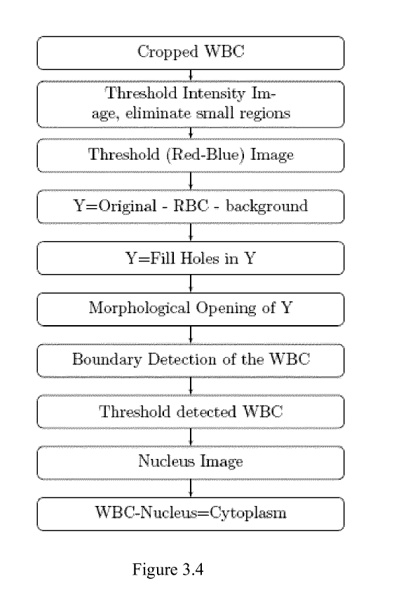

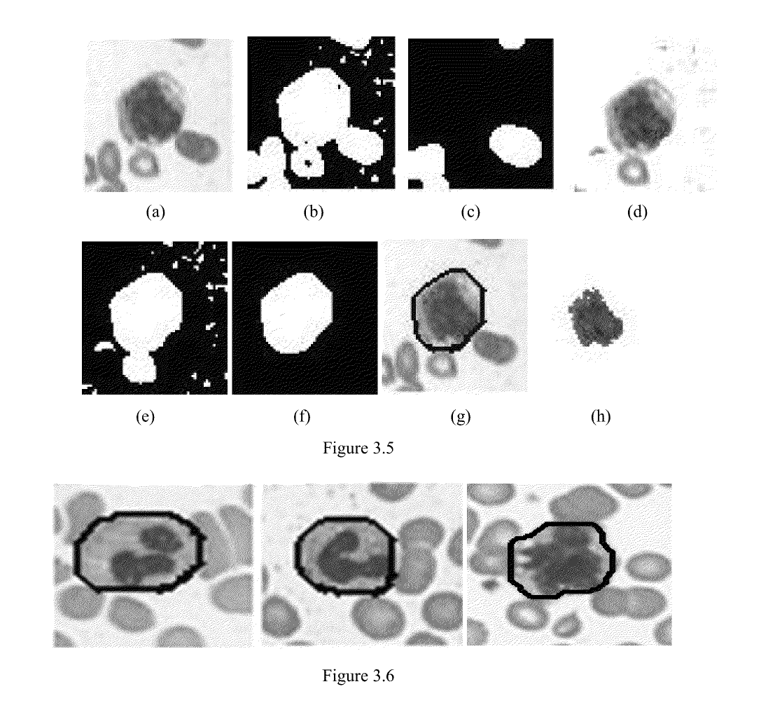

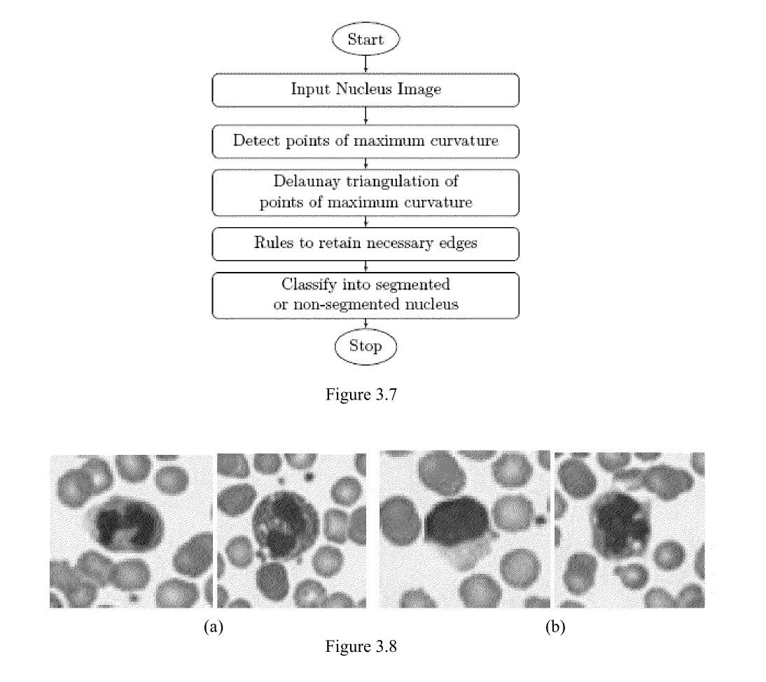

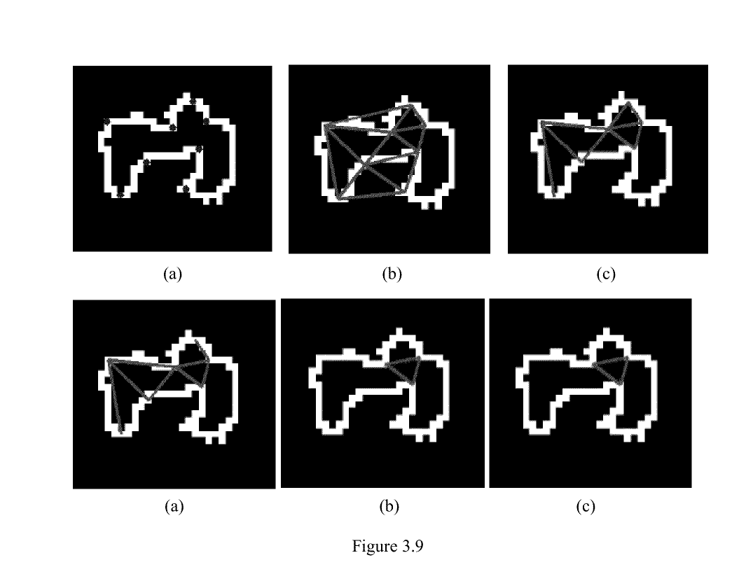

There are three types of cells in normal human blood: RBC, WBC, and platelets. Generally, RBC are simple and similar to each other. WBC contain nucleus and cytoplasm and there are different subtypes. For easy identification, the WBCs are stained with the Geisma stain, hence have a dark intensity. Since we have been using images from the same laboratory, the stains used on the slides are similar. We convert the image from RGB (Red, Green, Blue) to HSV (Hue, Saturation, Value) space. First, using the saturation image, we threshold it to obtain the nucleus approximately. Saturation refers to the dominance of hue in the color. A saturation value of 0 implies that the color is desaturated, the domination of hue is less. A saturation value of 1 indicates that there is maximum dominance of hue, pure color, thus the range for the saturation image is between 0 and 1. A threshold value of 0.55 is used in our experiment. We eliminate the extremely small regions based on their area. The advantage of using saturation image for thresholding is the elimination of illumination changes that occur in the image. FIG. 3.2 shows the original image and the saturation image. Finally, we crop the part around the nucleus making sure that the whole WBC is captured and save the result. We use the distance measure to check if two nuclei belong to the same WBC. FIG. 3.3 shows the cropped image containing the WBC. The advantage of using only the cropped image is that the regions containing mostly RBC are eliminated. We process all the images and record the detected WBCs. The advantage of this method is that we do not have any false negatives in the detection of the WBCs. We do capture some redundant cells (false positives) which have been stained, but we eliminate them in further processing by manually assigning them to a noise class. FIG. 3.1 depicts the flowchart for WBC detection.

We have implemented a novel and robust segmentation scheme for segmenting WBCs. First we threshold (threshold value=0.9) the given sub-image based on intensity and eliminate small regions to obtain a binary image. The intensities range between 0 and 255. The intensity images are scaled between 0 and 1 for thresholding. This eliminates the background pixels, leaving only the RBCs and WBC. We notice that the RBC are mostly pink/red in color and the WBC have a dark stained nucleus. We take advantage of the information present in the blue and red channels. Thresholding (threshold value=0.05) and smoothing the difference in the red and blue channels helps in eliminating a significant part of the RBCs. Subtracting the RBCs and the background from the original image results in an image with mostly WBC. Hence, we are left with the WBC which have possibly small parts of RBCs attached to them. We fill in details if lost due to our thresholding operation. A standard hole filling algorithm is used to fill in these details. Using a disk shaped structuring element we get rid of the thin parts (morphological opening) of the RBCs which are attached to the WBC. This procedure helps in detecting the boundary of the WBC. Once the WBC boundary has been extracted we concentrate on separating the WBC region into cytoplasm and nucleus. We use the saturation image again to threshold the detected WBC. This thresholding (threshold value=0.55) operation yields a binary image of the nucleus. By taking the difference between the WBC image and the nucleus image we get the cytoplasm regions. Hence this extremely fast method can be used to segment the blood image to get the desired results. FIG. 3.4 depicts the flowchart for the WBC segmentation. FIG. 3.5 gives a visual interpretation of the goals of each step in the segmentation algorithm. FIG. 3.6 shows examples of the segmented WBCs.

Segmented Vs. Non-Segmented Nucleus Classification

WBCs can be broadly classified into cells with segmented nucleus and cells with non-segmented nucleus as shown in FIG. 3.8. The nucleus shape is the key factor in deciding the class to which the WBC belongs. Deciding whether the nucleus is segmented or non-segmented first gives a significant advantage to the final classification process. Ambiguities associated with connected nuclei lobes are resolved by detecting local maximum curvature points, detecting concavities and partitioning them through geometric rules. The flowchart in FIG. 3.7 gives the steps for the classification of WBC into segmented and non-segmented WBC. FIG. 3.9 gives a visual interpretation of the goals of each step. The process of classification of the WBC into these two broad classes can be described in the following steps:

Detection of Maximum Curvature Points

The goal of this step is to identify local curvature maxima corresponding to sharp bends (corners). We utilize global and local curvature properties in extracting the maximum curvature points. After contour extraction we compute the curvature using Equation (3.5) and retain the local curvature maxima points.

$$κ = \frac{{x}^{′} {y}^{″} - {y}^{′} {x}^{″}}{{( {x}^{′2} + {y}^{′2} )}^{1.5}} \qquad ( 3.5 )$$

where x(s) and y(s) represents the x-coordinates and y-coordinates of the boundary points respectively. x′ and y′ represent the first derivatives with respect to s. x″ and y″ represent the second derivatives with respect to s.

Elimination of low curvature maxima is done by calculating an adaptive threshold according to the mean curvature within a region of interest. The region of interest (ROI) of a maximum curvature point is defined as the segment of the contour between the two nearest curvature minima points surrounding it denoted by L1 and L2. The ROI of each maximum curvature point is used to calculate a local threshold adaptively where p is the position of the maximum curvature point on the contour, and R is a coefficient:

$$T ( p ) = R \times \overline{κ} = R \times \frac{1}{{L}_{1} + {L}_{2} + 1} {\sum }_{i = p - {L}_{2}}^{p + {L}_{1}} \vert κ ( i ) \vert \qquad ( 3.6 )$$

\acute{κ} is the mean curvature of the ROI and i is the index of the point on the nucleus boundary.

The absolute value of the curvature is used to distinguish between low curvature maxim points against high curvature maxima points. A round corner (low curvature maxima) tends to have an absolute curvature larger than T(p), while a sharp corner (high curvature maxima) tends to have an absolute curvature larger than T(p). The reasoning for choosing an appropriate value of R can be found in He et al. A value of 1.5 is used for R in our experiment. FIG. 3.9(a) shows high curvature maxima detected from a contour.

Delaunay Triangulation of Points of Maximum Curvature

The goal of this step is to construct the set of all potential edges that might correspond to the boundaries between the different lobes of a segmented nuclei. The high curvature maxima found in the previous step are used as the candidate vertices for these edges. A triangle S from T satisfies the Delaunay criterion if the interior of the circumcircle through the vertices of S does not contain any points. If all triangles satisfy the Delaunay criterion then the triangulation T is called Delaunay triangulation. We apply the Delaunay Triangulation (DT) to all points of maximum curvature to find candidate edges which potentially separate different segments of the nuclei. The results for an example contour are shown in FIG. 3.9(b).

Rules to Retain Necessary Edges

Shape and color based rules: A set of conditions are first checked to see if a WBC has segmented nuclei.
We eliminate all edges if the nucleus has a roundness ratio >λ₁ and classify the cell as non-segmented nucleus type.
Eliminate all edges if the ratio of original area of nucleus to convex hull of nucleus >λ₂ and classify the cell as non-segmented nucleus type.
Find the ratio of the area of the red/pink regions to the area of the entire of WBC. The red/pink regions are found by taking the difference between the red and blue image (red−blue) and thresholding it to obtain a binary image. If the ratio is >λ₃, then the nucleus is classified directly without further processing as a segmented nucleus.

We used λ₁=0.75, λ₂=0.85, λ₃=0.3.
If there are two or more nuclei present in one cell, the nucleus is directly classified as a segmented nucleus.

Geometric rules: If the above reasons are not satisfied, a series of geometric rules helps us in separating the cells with segmented nucleus from the cells with non-segmented nucleus. Let sᵢⱼ be the edge connecting two points of maximum curvature maxima pᵢ and pⱼ. Tᵢ and Tⱼ are the unit vectors representing the tangent directions at pᵢ and pⱼ. The following set of rules are used:
Eliminate edges that pass through the background and edges that intersect the boundary. This criterion helps in retaining edges that are inside the nucleus only. (FIG. 3.9(c))
Eliminate edge sᵢⱼ if (Tᵢ·Tⱼ)>Th1, this retains edges only if angle between tangents Tᵢ and Tⱼ is close to π radians. In that case, the tangent vectors are parallel but have opposite directions. These edges are on opposite sides of the contour, hence this is a valid edge. (FIG. 3.9(d))
Eliminate edge if

$$max ( \vert {T}_{i} \cdot \frac{{s}_{ij}}{\vert {s}_{ij} \vert} \vert , \vert {T}_{j} \cdot \frac{{s}_{ji}}{\vert {s}_{ji} \vert} \vert ) > Th 2.$$

Valid edges are those for which the tangent vector and the edge vector are nearly perpendicular to each other. This condition retains edges in which the angle between the edge vector and the corresponding tangent vector is close to π/2 radians. (FIG. 3.9(e))
Eliminate edge sᵢⱼ if κᵢκⱼ<0. This eliminates edges if the end points of the edge have opposite curvatures. The curvature at the endpoints of the edge is in the same directions for valid edges. Hence, if the product of the curvatures at the end points is negative implies that the end points have opposite curvatures. (FIG. 3.9(f))

We used Th1=0 and Th2=0.4.

We check the above conditions for each edge in the Delaunay triangulation. Finally we check if the number of edges are greater than zero. If edges still remain then we classify the WBC as a cell with segmented nucleus. Otherwise, the WBC is classified as a cell with non-segmented nucleus.

An example of this classification is shown in FIG. 3.9. FIG. 3.9(a) shows the local curvature maxima points on the nucleus boundary. FIG. 3.9(b) shows the triangulation of the points of maximum curvature to find the candidate edges. In FIG. 3.9(c) the background edges have been eliminated. FIG. 3.9(d) retains edges if the angle between tangents is close to π radians. FIG. 3.9(e) retains edges if the edge vector and tangent vector are close to perpendicular. FIG. 3.9(f) retains edges if end points have curvatures in the same direction. Finally, three edges are present in the end indicating that the nucleus has three segments that are interconnected.

Automated Classification of WBC to its Subtype.

To classify the WBC to its respective subtype, we use features that describe the characteristics of the cytoplasm and the nucleus. We choose 19 features such as area, perimeter, convex area, solidity, orientation, eccentricity, separately evaluated for the nucleus and the WBC. The result obtained from the previous step gives us information about the broad nucleus type (segmented or non-segmented). This result is a novel binary feature added to our classifier. In addition special features like “circularity” (ratio between the perimeter of the tightest bounding circle and the nucleus perimeter) of the nucleus, nucleus to cytoplasm ratio, ratio of nucleus area to area of WBC, entropy of the cytoplasm and mean gray-level intensity of the cytoplasm (all 3 color channels) are computed. Fishers linear discriminant is used to reduce our multi-dimensional data set to six dimensions. We use a linear discriminant in this 6-dimensional space to classify the data to its respective type. The classifier is biased using the number of samples in each class. The system is evaluated using 10-fold cross-validation.

Segmentation Results

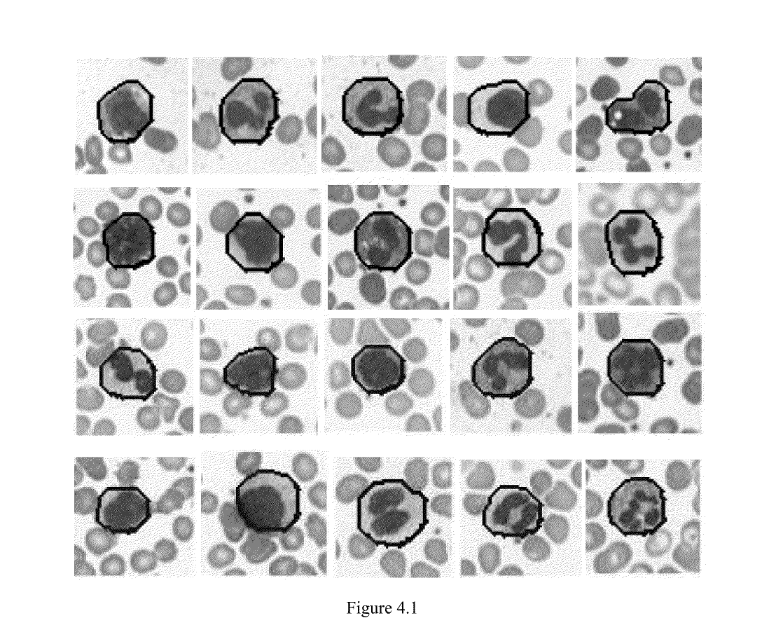

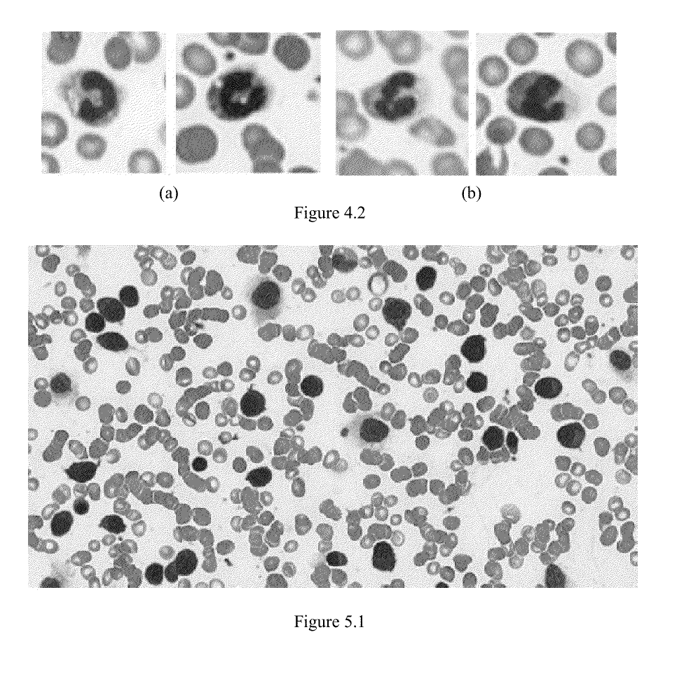

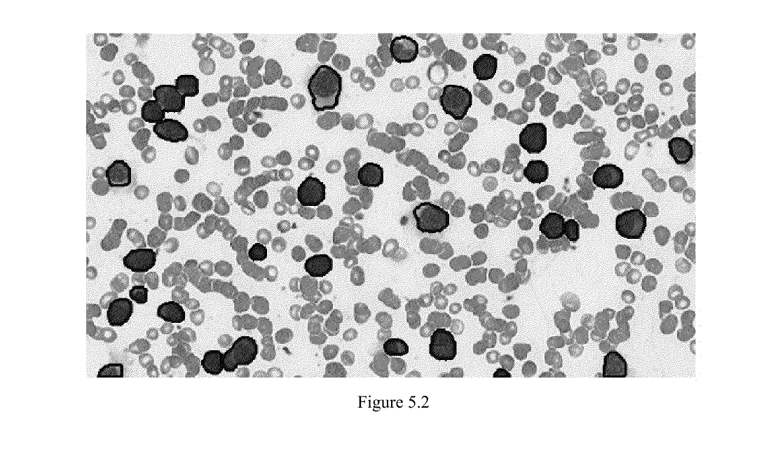

This system has been tested using images obtained from the ARUP Laboratory, University of Utah. Our dataset consists of 320 images that contain 1,938 expert labeled WBCs. The input images have been processed to detect the WBCs. We obtained 1,938 sub-images with single correctly positioned WBCs. We did not have any false negatives in the detection of WBCs. The false positive rate was 10.25%. We eliminated the false positives by manually assigning them to a noise class. The performance of the segmentation algorithm was evaluated by comparing our proposed method with a hematologist's visual segmentation. The segmentation algorithm was applied to 1,938 subimages of WBCs, 1,804 of them were accurately segmented. The accuracy rate for segmentation was 93.08%. FIG. 4.1 shows some segmentation results.

Classification Results

A vector of 19 features were extracted for every WBC. The experts associated the correct classification of each extracted WBC. The resulting dataset (1,938 (number of cells)×19 (features)) has been used to determine the subtype of the WBC segmented using linear discriminants as described herein. The system was evaluated using 10-fold cross-validation technique.

We observed that there is a lot of misclassification between segmented neutrophils and bands, segmented neutrophils and eosinophils, segmented neutrophils and lymphocytes, segmented neutrophils and monocytes as seen in Table 4.1. The rows in the confusion matrix represent the real subtype and the columns represented the detected subtype. An initial classification of the WBC into cells with segmented nucleus (neutrophils, eosinophils, basophils) and cells with single nucleus (band, lymphocyte, monocyte) improves the performance of the classification. The accuracy of classification is improved for all the classes, see Table 4.2.

TABLE 4.1
Confusion matrix using regular classification (6 subtypes). Rows represent
the correct classification by experts. For each row, the columns represent
the classification made by our algorithm. Diagonal entries indicate correct
classification and are indicated in bold.

| | | | Eosin- | | Lym- | |
|---|---|---|---|---|---|---|
| Type | Band | Neutrophil | ophil | Basophil | phocyte | Monocyte |
| Band | 2 | 50 | 1 | 0 | 1 | 1 |
| Neutrophil | 2 | 734 | 8 | 1 | 20 | 10 |
| Eosinophil | 0 | 23 | 33 | 1 | 0 | 0 |
| Basophil | 0 | 0 | 0 | 4 | 1 | 0 |
| Lym- | 0 | 30 | 2 | 5 | 242 | 19 |
| phocyte | | | | | | |
| Monocyte | 1 | 13 | 3 | 1 | 7 | 40 |

TABLE 4.2
Confusion matrix using our novel 2-step classification (6 subtypes). Rows
represent the correct classification by experts. For each row, the columns
represent the classification made by our algorithm. Diagonal entries
indicate correct classification and are indicated in bold.

| | | | Eosin- | | Lym- | |
|---|---|---|---|---|---|---|
| Type | Band | Neutrophil | ophil | Basophil | phocyte | Monocyte |
| Band | 33 | 99 | 0 | 0 | 4 | 4 |
| Neutrophil | 42 | 1124 | 9 | 0 | 2 | 5 |
| Eosinophil | 0 | 18 | 48 | 0 | 3 | 0 |
| Basophil | 0 | 0 | 0 | 8 | 0 | 0 |
| Lym- | 0 | 10 | 2 | 11 | 362 | 24 |
| phocyte | | | | | | |
| Monocyte | 0 | 5 | 1 | 2 | 16 | 97 |

We see that one of the important misclassification still prevalent is in the band class. The data from the class “Band” and class “Segmented Neutrophil” seem to overlap each other because of similar features. The segmented neutrophils are just a mature stage of the bands, hence they have similar features. It is difficult to differentiate between these two subtypes. FIG. 4.2(a) and FIG. 4.2(b) shows examples of band and segmented neutrophil respectively. Since segmented neutrophils is a mature stage of the band, we consider combining these two categories into the more general class of neutrophils. This five subtype classification is generally performed by pathologists. Hence, considering only the five subtypes for the WBC, we obtain very good classification results for the given dataset as seen in Table 4.3.

TABLE 4.3
Confusion matrix using our novel 2-step classification (5 subtypes). Rows
represent the correct classification by experts. For each row, the columns
represent the classification made by our algorithm. Diagonal entries
indicate correct classification and are indicated in bold.

| Type | Neutrophil | Eosinophil | Basophil | Lymphocyte | Monocyte |
|---|---|---|---|---|---|
| Neutrophil | 1289 | 9 | 0 | 6 | 8 |
| Eosinophil | 19 | 46 | 1 | 3 | 0 |
| Basophil | 0 | 0 | 8 | 0 | 0 |
| Lym- | 10 | 3 | 11 | 362 | 23 |
| phocyte | | | | | |
| Monocyte | 5 | 1 | 2 | 16 | 97 |

Results indicate that the morphological analysis of white blood cells is achievable and it offers good classification accuracy.

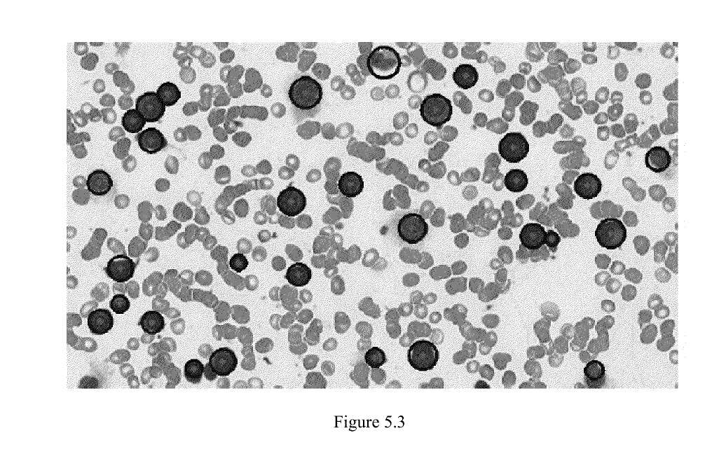

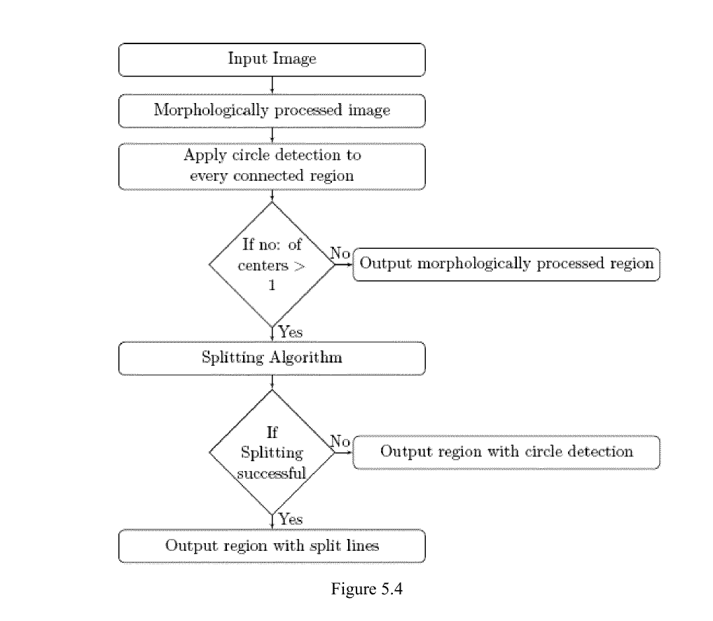

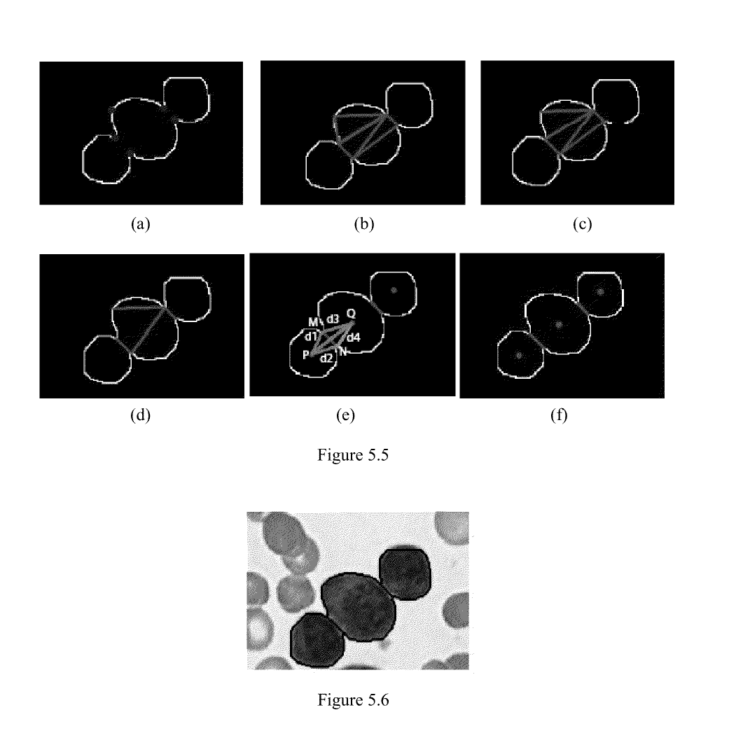

We developed an automated system for the detection and segmentation of hematopoietic cells from aspirate smears in the bone marrow. Hematopoietic cell counting is performed by pathologists only in thin sections of the aspirate smear. Similarly, we manually pick these regions and store the images corresponding to the thin sections of the aspirate smear. There are three main categories of hematopoietic cells: Erythrocyte or Normoblast differentiation series, Leukocyte differentiation series and megakaryocytes. Erythrocyte or Normoblast differentiation series help in the production of RBC. Leukocyte differentiation series help in the production of WBCs. Megakaryocytes are responsible for the production of platelets. FIG. 5.1 shows an example bone marrow sample.

Hematopoietic Cell Segmentation in Bone Marrow

We implemented a novel scheme for segmenting the hematopoietic cells in bone marrow. First we threshold the given image based on intensity and eliminate small regions to obtain a binary image (threshold value=0.7). This eliminates the background pixels, leaving only the RBC, clumped platelets and the hematopoietic cells. We notice that the RBC are mostly pink in color and the hematopoietic cells have a dark stained nucleus. We take advantage of the information present in the blue and red channels. Thresholding and smoothing the difference in the red and blue channels helps in eliminating a significant portion of the RBCs (threshold value=0.05). Subtracting the RBCs and the background from the original image results in an image with mostly hematopoietic cells and clumped platelets. Hence, we are left with the hematopoietic cells which have possibly small parts of RBCs attached to them. We fill in details if lost due to our thresholding operation. A standard hole filling algorithm is used to fill in these details. Using a disk shaped structuring element we get rid of the thin parts (morphological opening) of the RBC which are attached to the hematopoietic cells. FIG. 5.2 shows the morphologically processed bone marrow sample.

Cell regions that are very close to each other are detected as a single cell. The clumped cells are segmented using circle detection on the morphologically processed image and a splitting algorithm based on the position and number of detected circle centers. We used the Circular Hough Transform to detect the circles present in each connected region. Given the equation for a circle, (x−a)²+(y−b)²=r², the detection of circles require a 3D parameter space (a; b; r). An accumulator array is built with the following steps:

1. First we find all edges in the image using the color thresholding and morphological filtering procedures described above.

2. Then, at each edge point we increment the accumulator cells corresponding to the circle in the parameter space with center in the point with the desired radius.

3. Step 2 is repeated for all admissible radii.

The accumulator cells then contain numbers corresponding to the number of circles that fit the specific parameters represented by the cells. We find one or several local maxima in the accumulator, which correspond to the circles in the image. The detected center and the radius of the circle is saved for every region.

Circle detection helps in identifying the number of centers in a given region. The regions containing one or more cells generally have one or more lobes, where each lobe typically corresponds to a single cell. Each circle that is detected by the procedure outlined above substantially covers a lobe of the region. The splitting of these lobes, described below, then helps provide a count of the number of single cells in the cluster that is encompassed by the region. An example of circular detection on the morphologically processed image is shown in FIG. 5.3. Further processing of a region is based on the number of centers detected. FIG. 5.4 represents the flowchart for the segmentation algorithm. If a single center is detected, no further processing is done, since there is only one cell in that region and the morphological segmentation is correct. If more than one center is present then a splitting algorithm based on the information from the centers is implemented. For every center P in the region being processed, the neighboring center Q is found. PQ denotes the line segment connecting the centers. The co-ordinates of the centers P and Q are denoted as (xₚ, yₚ) and (x_{q}, y_{q}) respectively. MN represents the edge under consideration. The co-ordinates of the endpoints M, N are (xₘ, yₘ) and (xₙ, yₙ) respectively. d1, d2, d3, d4 represent the lengths of PM, PN, QM, QN respectively, FIG. 5.5(e). The splitting algorithm can be explained in the following steps:

1. Detection of maximum curvature points on the boundary. FIG. 5.5(a)

2. Delaunay Triangulation of Points of Maximum Curvature. This step is used to construct the set of all potential edges that might correspond to the boundaries between the different cells that are clumped together. Let sᵤ be the edge connecting two points of maximum curvature maxima pᵢ and pⱼ. Tᵢ and Tⱼ are the unit vectors representing the tangent directions at pᵢ and pⱼ. FIG. 5.5(b)

3. Eliminate edges that pass through the background and edges that intersect the boundary. This criterion helps in retaining edges that are inside the region only. FIG. (5.5(c))

4. Eliminate edge sᵢⱼ if (Tᵢ·Tⱼ)>0, this retains edges only if the angle between the tangents Tᵢ and Tⱼ is close to π radians. These edges have the two endpoints on opposite sides of the contour, hence this is a valid edge. FIG. 5.5(d)

5. The edge points M and N are valid when xₘ, xₙε(xₚ, x_{q})∪yₘ, yₙε(yₚ, y_{q}).

6. The distance between midpoint of PQ and MN should be less than a threshold, e.g. T=15 pixels.

7. The edge is valid if |d1−d2|+d3−d4|<e.g. 25 pixels, i.e. the endpoints are approximately equidistant from the edges. If no edges are found then the neighboring center is chosen once again to get the next closest center and the last three steps are repeated. FIGS. 5.5(e), 5.5(f)

Steps 5-7 represent automated mechanisms for validating the edge as a valid location to split the adjacent lobes of the first region. FIG. 5.5 gives a visual interpretation of the goals of each step. Circle detection followed by splitting helps in identifying the hematopoietic cells that are very close to each other. The clumped hematopoietic cells are detected now as separate cells as shown in FIG. 5.6. The splitting technique is successful when the number of valid edges in a region are equal to the number of detected centers in that region−1. Then the split lines are used to segment the cells in the region. Otherwise the circles in the region using Hough Transform are used for segmentation of the cells.

Regions that have clumped platelets or RBCs get detected as possible cells. We consider each of the regions detected, threshold it at a high intensity value to retain only the nucleus. The thresholded regions are processed using morphological opening. If the number of objects in the morphologically processed region is zero then the region is eliminated. In this manner the region containing only platelets or RBCs can be eliminated.

This system has been tested using images obtained from the ARUP Laboratory, University of Utah. Our dataset consists of 334 images that contain 3,748 expert-labeled hematopoietic cells. The false negative rate was 1.62% in the detection of hematopoietic cells. The false positive rate was 1.2%, 3,525 of them were accurately segmented. The performance of the segmentation algorithm was evaluated by comparing our proposed method with a hematologist's visual segmentation. The accuracy rate for segmentation was 94.05%. FIGS. (6.1, 6.2, 6.3) show segmentation results.

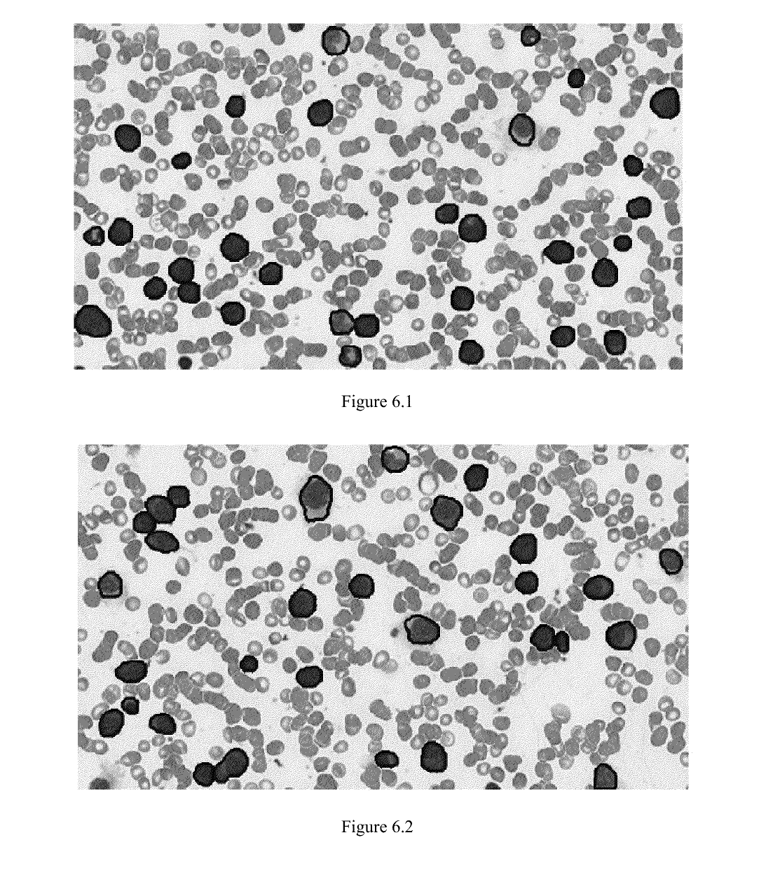

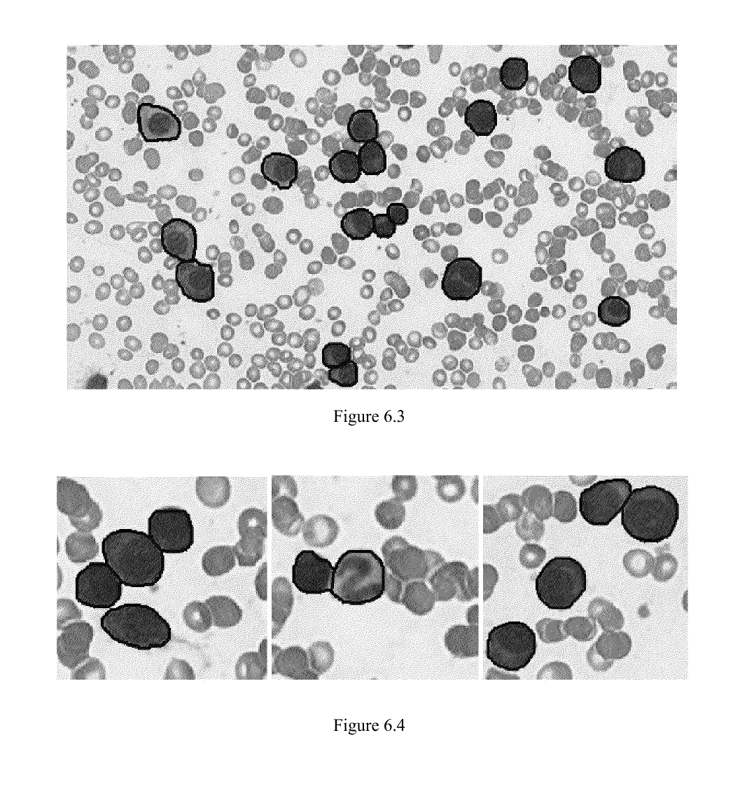

FIGS. 6.4 and 6.5 give a magnified view of the results of segmentation of hematopoietic cells. The successful segmentation of the cytoplasm along with the nucleus segmentation aids in the automatic classification of the hematopoietic cells. The algorithm has low computation cost but good accuracy.

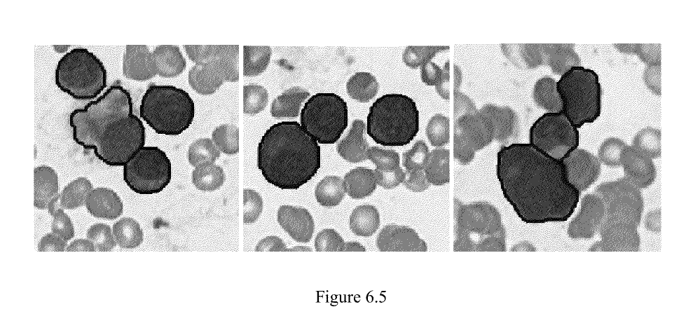

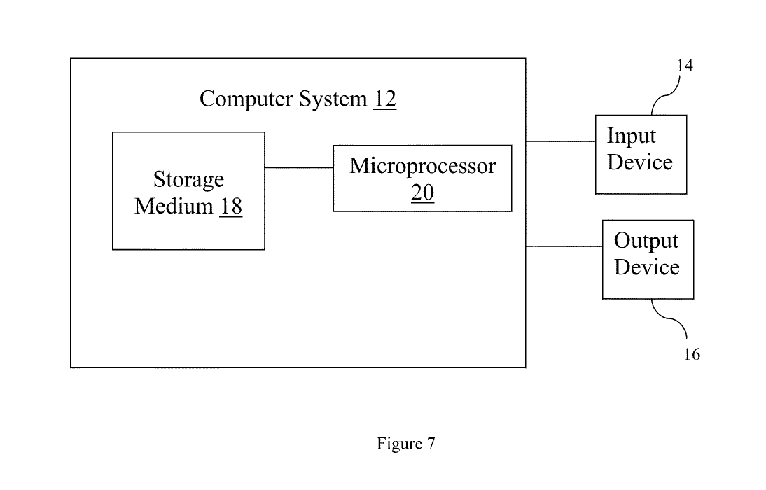

As discussed above, in various embodiments, the disclosed methods may be implemented on one or more computer systems 12 such as that shown in FIG. 7. Each computer system 12 may be in wired or wireless communication with one another through a combination of local and global networks including the Internet. Each computer system 12 may include one or more input device 14, output device 16, storage medium 18, and microprocessor 20. Possible input devices include a keyboard, a computer mouse, a touch pad, a touch screen, a digital tablet, a microphone, a track ball, and the like. Output devices include a cathode-ray tube (CRT) computer monitor, a liquid-crystal display (LCD) or LED computer monitor, touch screen, speaker, and the like. Storage media include various types of local or remote memory devices such as a hard disk, RAM, flash memory, and other magnetic, optical, physical, or electronic memory devices. The microprocessor 20 may be any typical computer microprocessor for performing calculations and directing other functions for performing input, output, calculation, and display of data in accordance with the disclosed methods. In various embodiments, implementation of the disclosed methods includes generating sets of instructions and data (e.g. including image data and numerical data) that are stored on one or more of the storage media and operated on by a controller.

In some embodiments, implementation of the disclosed methods may include generating one or more web pages for facilitating input, output, control, analysis, and other functions. In other embodiments, the methods may be implemented as a locally-controlled program on a local computer system which may or may not be accessible to other computer systems. In still other embodiments, implementation of the methods may include generating and/or operating modules which provide access to portable devices such as laptops, tablet computers, digitizers, digital tablets, smart phones, and other devices.

Each of the following references is hereby incorporated by reference in its entirety:
[1] Heidi Berge, Dale Taylor, Sriram Krishnan, and Tania S. Douglas. Improved red blood cell counting in thin blood smears. In IEEE International Symposium on Biomedical Imaging, 2011.
[2] Leyza Baldo Dorini, Rodrigo Minetto, and Neucimar Jeronimo Leite. White blood cell segmentation using morphological operators and scale-space analysis. Graphics, Patterns and Images, SIBGRAPI Conference on, 0:294-304, 2007.
[3] Rafael C. Gonzalez and Richard E. Woods. Digital Image Processing. Addison-Wesley Longman Publishing Co., Inc., Boston, Mass., USA, 2nd edition, 2001.
[4] M. Hamghalam and A. Ayatollahi. Automatic counting of leukocytes in giemsa-stained images of peripheral blood smear. In Digital Image Processing, 2009 International Conference on, pages 13-16, March 2009.
[5] X. C. He and N. H. C. Yung. Curvature scale space corner detector with adaptive threshold and dynamic region of support. In Pattern Recognition, 2004. ICPR 2004. Proceedings of the 17th International Conference on, volume 2, pages 791-794 Vol. 2, August 2004.
[6] Kan Jiang, Qing-Min Liao, and Sheng-Yang Dai. A novel white blood cell segmentation scheme using scale-space filtering and watershed clustering. In Machine Learning and Cybernetics, 2003 International Conference on, volume 5, pages 2820-2825 Vol. 5, November 2003.
[7] B. R. Kumar, D. K. Joseph, and T. V. Sreenivas. Teager energy based blood cell segmentation. In Digital Signal Processing, 2002. DSP 2002. 2002 14th International Conference on, volume 2, pages 619-622 vol. 2, 2002.
[8] V. D Liseikin. Grid Generation Methods. Springer Verlag, Berlin, 1999.
[9] G. Ongun, U. Halici, K. Leblebicioglu, V. Atalay, M. Beksac, and S. Beksac. Feature extraction and classification of blood cells for an automated differential blood count system. In Neural Networks, 2001. Proceedings. IJCNN '01. International Joint Conference on, volume 4, pages 2461-2466 vol. 4, 2001.
[10] Jae-Sang Park and J. M. Keller. Fuzzy patch label relaxation in bone marrow cell segmentation. In Systems, Man, and Cybernetics, 1997. ‘Computational Cybernetics and Simulation’., 1997 IEEE International Conference on, volume 2, pages 1133-1138 vol. 2, October 1997.
[11] V. Piuri and F. Scotti. Morphological classification of blood leucocytes by microscope images. In Computational Intelligence for Measurement Systems and Applications, 2004. CIMSA. 2004 IEEE International Conference on, pages 103-108, July 2004.
[12] A. Rattarangsi and R. T. Chin. Scale-based detection of corners of planar curves. Pattern Analysis and Machine Intelligence, IEEE Transactions on, 14(4):430-449, April 1992.
[13] S. H. Rezatofighi, H. Soltanian-Zadeh, R. Sharifian, and R. A. Zoroofi. A new approach to white blood cell nucleus segmentation based on gram-schmidt orthogonalization. In Digital Image Processing, 2009 International Conference on, pages 107-111, March 2009.
[14] Farnoosh Sadeghian, Zainina Seman, Abdul Rahman Ramli, Badrul Hisham Abdul Kahar, and M-Iqbal Saripan. A framework for white blood cell segmentation in microscopic blood images using digital image processing. Biological Procedures Online, 11:196-206, 2009. 10.1007/s12575-009-9011-2.
[15] P. Sobrevilla, E. Montseny, and J. Keller. White blood cell detection in bone marrow images. In Fuzzy Information Processing Society, 1999. NAFIPS. 18th International Conference of the North American, pages 403-407, July 1999.
[16] Keith Breden Taylor and Julian B. Schorr. Blood, colliers encyclopaedia, Vol 4, 1978.
[17] Nipon Theera-Umpon. Automatic white blood cell classification in bone marrow images using morphological features. http://mis.eng.cmu.ac.th/download/publication/22_file.pdf.
[18] www.labtestsonline.org/understanding/analytes/bonemarrow/test.html.
[19] Quan Wen, Hang Chang, and Bahram Parvin. A delaunay triangulation approach for segmenting clumps of nuclei. In Proceedings of the Sixth IEEE international conference on Symposium on Biomedical Imaging: From Nano to Macro, ISBI'09, pages 9-12, Piscataway, N.J., USA, 2009. IEEE Press.
[20] G W Zack, W E Rogers, and S A Latt. Automatic measurement of sister chromatid exchange frequency. Journal of Histochemistry and Cytochemistry, 25(7):741-53, 1977.
[21] Norberto Malpica, Carlos Ortiz de Solrzano, Juan Jos Vaquero, Andrs Santos, Isabel Vallcorba, Jos Miguel Garca-Sagredo, and Francisco del Pozo, “Applying watershed algorithms to the segmentation of clustered nuclei,” Cytometry, vol. 28, no. 4, pp. 289-297, 1997.
[22] H. Berge, D. Taylor, S. Krishnan, and T. S. Douglas, “Improved red blood cell counting in thin blood smears,” in IEEE International Symposium on Biomedical Imaging: From Nano to Macro, April 2011, pp. 204-207.
[23] Hui Kong, M. Gurcan, and K. Belkacem-Boussaid, “Splitting touching-cell clusters on histopathological images,” in IEEE International Symposium on Biomedical Imaging: From Nano to Macro, April 2011, pp. 208-211.
[24] Quan Wen, Hang Chang, and Bahram Parvin, “A delaunay triangulation approach for segmenting clumps of nuclei,” in Proceedings of the Sixth IEEE international conference on Symposium on Biomedical Imaging: From Nano to Macro, Piscataway, N.J., USA, 2009, ISBI'09, pp. 9-12, IEEE Press.

Thus, the invention provides, among other things, a {text}. Various features and advantages of the invention are set forth in the following claims.

What is claimed is:

1. A method of identifying individual cells in an image of a cytological preparation, comprising:
obtaining an image of a cytological preparation comprising a plurality of cells;
identifying a first region of the image, the first region having a region boundary encompassing at least one lobe, wherein the first region includes at least one cell;
detecting at least one circle within the first region, where the at least one circle substantially covers the at least one lobe of the first region; and
if the first region has more than one circle, splitting the region into at least two subregions.

2. The method of claim 1, wherein detecting at least one circle within the first region comprises detecting at least one circle within the first region using a circular Hough transform.

3. The method of claim 2, wherein splitting the region into at least two subregions comprises
i) identifying a plurality of maximum curvature points on the region boundary,
ii) generating a plurality of vectors connecting pairs of the plurality of maximum curvature points, and
iii) eliminating invalid vectors to produce a set of remaining vectors,
iv) for each of the remaining vectors
a) determining a tangent for each of the maximum curvature points, where each tangent has an angle,
b) comparing the angles of the tangents, and
c) eliminating the remaining vector if the difference between the angles of the tangents is not approximately equal to pi radians to produce a set of final vectors, and
v) splitting the region into at least two subregions using at least one of the final vectors.

4. The method of claim 3, wherein eliminating invalid vectors comprises eliminating any of the plurality of vectors which cross the region boundary or which are not within the first region.

5. The method of claim 4, wherein generating a plurality of vectors connecting pairs of the plurality of maximum curvature points comprises generating a plurality of vectors connecting pairs of the plurality of maximum curvature points using Delaunay triangulation.

6. The method of claim 5, further comprising validating the final vectors.

7. The method of claim 1, wherein identifying a first region comprises
thresholding the image;
subtracting a first color channel of the image from a second color channel of the image to selectively remove a first set of image features;
applying a hole filling algorithm; and
applying a disk-shaped structuring element.

8. The method of claim 1, wherein each of the at least two subregions includes a cell.

9. The method of claim 1, wherein the first region includes a plurality of lobes, wherein each of the plurality of lobes has a cell therein, and wherein splitting the region into at least two subregions comprises splitting the region such that each subregion comprises one of the plurality of lobes.

10. The method of claim 1, further comprising segmenting at least a portion of the first region into a nuclear region and a cytoplasmic region.

11. The method of claim 10, wherein segmenting at least a portion of the first region into a nuclear region and a cytoplasmic region comprises applying at least one of the following steps to the first region:
thresholding the first region based on intensity;
thresholding the first region based on RGB color channel differences;
applying a disk-shaped structuring element;
identifying a boundary of a nucleus to obtain the nuclear region; and
subtracting the nuclear region from the first region to obtain the cytoplasmic region.

12. The method of claim 11, further comprising quantifying a staining intensity in at least one of the nuclear region and the cytoplasmic region.

13. The method of claim 1, wherein the cytological preparation comprises bone marrow cells.

14. The method of claim 1, further comprising executing at least one step using a microprocessor.

15. The method of claim 1, further comprising displaying a result to a user on an output device, wherein the result is one of an image or a numerical value.

16. A computer-readable medium, comprising:
first instructions executable on a computational device for obtaining an image of a cytological preparation comprising a plurality of cells;
second instructions executable on a computational device for identifying a first region of the image, the first region having a region boundary encompassing at least one lobe, wherein the first region includes at least one cell;
third instructions executable on a computational device for detecting at least one circle within the first region, where the at least one circle substantially covers the at least one lobe of the first region; and
fourth instructions executable on a computational device for splitting the region into at least two subregions if the first region has more than one circle.

17. A computer-based system for identifying individual cells in an image of a cytological preparation, the system comprising:
a microprocessor; and
a storage medium operably coupled to the microprocessor, wherein the storage medium includes,
program instructions executable by the microprocessor for
obtaining an image of a cytological preparation comprising a plurality of cells;
identifying a first region of the image, the first region having a region boundary encompassing at least one lobe, wherein the first region includes at least one cell;
detecting at least one circle within the first region, where the at least one circle substantially covers the at least one lobe of the first region; and
if the first region has more than one circle, splitting the region into at least two subregions.
